(19) United States
(12) Patent Application Publication
(10) Pub. No.: US 2025/0253886 A1
(43) Pub. Date: Aug. 7, 2025

(54) METHOD FOR ENCODING AND DECODING A UWB MESSAGE USING A MODULATION GENERATING A TIME OFFSET OF THE DATA BITS

(71) Applicant: APITRAK SAS, MEYLAN (FR)

(72) Inventor: Jan MENNEKENS, TOULOUSE (FR)

(21) Appl. No.: 18/857,048

(22) PCT Filed: May 4, 2023
(86) PCT No.: PCT/EP2023/061772

§ 371 Date: Oct. 15, 2024

(30) Foreign Application Priority Data
May 4, 2022 (FR) FR2204249

(51) Int. Cl. H04B 1/7073; H04B 1/7163; H04W 64/00

(52) U.S. Cl. CPC H04B 1/70735; H04B 1/7163; H04W 64/006

(57) ABSTRACT

A computer-implemented method for encoding at least one data message intended to be transmitted by a UWB transmitter to a UWB receiver, the method including generation of a header encoded by a first pseudo-random code, the header defining a time reference after which a sequence of data segments is intended to be transmitted; generation of the sequence of data segments, each data segment encoding at least one payload data value by a second pseudo-random code and from the time reference, a position of the data segment in the sequence, an autocorrelation peak of the second pseudorandom code.

### INVENTION FIELD

The field of the invention relates to the transmission of information using radio signals. In particular, the field of the invention pertains to the modulation of UWB signals. More specifically, the field of the invention relates to the encoding of information to be transmitted using UWB signals.

### STATE OF THE ART

The acronym “UWB” (Ultra-Wide Band) refers to ultra-wideband radio signals emitted by one or more transmitting devices to one or more receiving devices, with an instantaneous frequency spectrum greater than 500 megahertz (at −10 dB relative to the maximum power of said instantaneous frequency spectrum). Additionally, a UWB signal is relatively insensitive to attenuation due to the multiple paths taken by a radio wave. A UWB signal can therefore provide good spatial and temporal resolutions.

It is known in the prior art to implement systems for locating one or more devices transmitting radio signals, particularly UWB signals. Such transmitting devices may, for example, be embodied as radio tags and emit signals toward one or more receiving devices, for example, embodied as one or more beacons. To detect the position of the transmitter, it is common practice to estimate the arrival time of the transmitted signal. This time-of-arrival estimation is, for example, achieved by implementing a digital correlator at the receiver, which generates correlation peaks at sampling instants of the received signal. The accuracy of the message arrival time estimate is then correlated with the location accuracy of the transmitting device. The estimated time of arrival of the signal then corresponds to the instant of detection of the first correlation peak whose amplitude exceeds a predetermined threshold. Due to its very short duration, a pulse has very fast rising and falling edges, which makes it possible to determine a very precise arrival time of a pulse at a UWB signal receiving device. It is also possible to clearly distinguish the shortest path from the other paths taken by the radio wave. All this helps to optimize the estimation of the geographical position of a device transmitting a UWB signal based on the signal's arrival time.

To estimate the arrival time of a transmitted message, various methods are known in the prior art. For example, it is known to implement a direct sequence spread spectrum modulation method (better known by the acronym DSSS in the Anglo-Saxon literature). In such a method, a data message is encoded as a sequence of bits, and each bit is modulated with a pseudo-random code. The transmitted message is then decoded at the receiver by sampling the received signal and performing correlation calculations based on the received signal and a reference signal. With this method, the accuracy of the message arrival time estimate depends on the sampling frequency of the received signal: the higher the sampling frequency, the better the message arrival time estimate. However, one disadvantage of this method is that increasing the sampling frequency to improve the arrival time estimate generates significant costs, both in terms of hardware and system power consumption. Moreover, such a method is no longer advantageous once the Nyquist frequency is reached.

It is also known to use “all-or-nothing” modulation, also known in the Anglo-Saxon literature as “ON-OFF Keying.” In this type of modulation, each binary sequence is composed of binary symbols that can take two states: a first state and a second state. The second state corresponds, for example, to the opposite of the first state. For example, the first state is represented by the value “1” and the second state by the value “−1,” corresponding respectively to the presence or absence of a pulse. However, one drawback of such modulation is the difficulty of detecting the signal due to its low spectral energy.

One aim of the invention is to overcome the disadvantages of the prior art by proposing a method for encoding and decoding a UWB message, enabling more precise localization, with improved range, and requiring low power consumption.

### SUMMARY OF THE INVENTION

According to a first aspect, the invention relates to a computer-implemented method for encoding at least one data message intended to be transmitted by a UWB transmitter to a UWB receiver, the method comprising:
Generating a header encoded by a first pseudo-random code, said header defining a time reference after which a sequence of data segments is intended to be transmitted;
Generating the sequence of data segments, each data segment encoding at least one useful data value by means of a second pseudo-random code and from:
   the time reference,
   a position of the data segment in the sequence;
   an autocorrelation peak of the second pseudorandom code.

One advantage is to improve the accuracy of calculating the arrival time of the data message. Another advantage is to reduce the energy consumption of a UWB localization system. Another advantage is to improve the location accuracy of a transmitting device.

In one embodiment, each data segment comprises a set of bits, the method comprising a time-shifting operation of a subset of bits encoding the useful data value of at least one data segment of the sequence of data segments to position said subset of bits at the first position in the data segment.

An advantage is to shift the position of an autocorrelation peak of the data message to improve decoding of a useful data of said data message.

In one embodiment, the method comprises generating the first pseudo-random code and/or the second pseudo-random code from an initial pseudo-random code.

In one embodiment, the first pseudo-random code or the second pseudo-random code is generated by replacing at least one bit of the initial pseudo-random code with a replacement pseudo-random code.

In one embodiment, each bit of the first replacement pseudo-random code is replaced by a replacement second pseudo-random code.

In one embodiment, the initial pseudo-random code comprises a first Barker sequence and the first replacement pseudo-random code comprises a second Barker sequence.

In one embodiment, the second replacement pseudo-random code comprises a third Barker sequence.

In one embodiment, the first Barker sequence, the second Barker sequence and the third Barker sequence are the same Barker sequence. Alternatively, they are different Barker sequences. For example, they are Barker sequences of different lengths.

One advantage is to encode data with shorter sequences while maintaining a minimum autocorrelation value.

In one embodiment, the method comprises generating a plurality of second pseudo-random codes from the initial pseudo-random code by successively applying time shifts of a predefined number of bits to the initial pseudo-random code and wherein the generation of the segment set is performed using the plurality of second pseudo-random codes.

One advantage is to obtain a minimum autocorrelation value while simplifying the decoding of transmitted data.

Another advantage is to optimize the orthogonality of the data codes.

In one embodiment, the first pseudo-random code has a greater number of bits than the second pseudo-random code.

One advantage is to achieve higher precision on a time reference used subsequently to determine the arrival time and autocorrelation peaks of segments of a data message.

According to another aspect, the invention relates to a computer-implemented method for locating a transmitter comprising encoding the data message according to the first aspect of the invention, the method comprising receiving a plurality of data messages by a plurality of UWB beacons, each beacon comprising a clock, said receiving comprising:
synchronizing the UWB beacon clocks;
time-stamping, by each clock, the reception of data messages;
calculating the position of the transmitter from the data messages received by the plurality of UWB beacons;

According to another aspect, the invention relates to a computer-implemented method for decoding at least one data message encoded by the method according to the first aspect of the invention and transmitted by a UWB transmitter comprising:
Measuring a first arrival signal, demodulating the the first arrival signal and calculating a first autocorrelation function of the demodulated signal;
Determining the autocorrelation peak of the first autocorrelation function;
Determining the time reference from said autocorrelation peak;
Measuring a plurality of second arrival signals, demodulating the second arrival signals and, for each second arrival signal,
   Calculating a second autocorrelation function for the second demodulated signal
   Determining an autocorrelation peak of the second autocorrelation function
   Measuring a time offset between the time reference or the start of a data segment and the autocorrelation peak;
   Decoding a useful data value according to the measured offset.

According to one embodiment, applying the second autocorrelation function comprises implementing a time shifting operation of at least one bit of at least one data segment of the sequence of data segments of the second pseudo-random code.

According to another aspect, the invention relates to a UWB transmitter comprising a calculator configured to implement the steps of the encoding method.

According to another aspect, the invention relates to a UWB receiver comprising a computer configured to implement the steps of the decoding method.

According to another aspect, the invention relates to a system for encoding and decoding at least one data message comprising a UWB transmitter.

According to another aspect, the invention relates to a system for encoding and decoding at least one data message comprising a UWB transmitter and a plurality of UWB beacons each comprising:
a clock for measuring timestamp data of the reception of data messages transmitted by the UWB transmitter;
a calculator for:
   Synchronizing the clocks of the plurality of UWB beacons with each other;
   Calculating, by trilateration, the position of the UWB transmitter at the origin of the data message.

### BRIEF DESCRIPTION OF FIGURES

Other features and advantages of the invention will become apparent from the following detailed description, with reference to the appended figures, which illustrate:

FIG. 1: An example in which a data message comprises a header and a set of segments containing useful data.

FIG. 2: Transmission of data messages from a UWB transmitting device to a receiving device.

FIG. 3: A header and a data segment encoded by two pseudo-random codes of different lengths.

FIG. 4: An example in which a first data message comprises the header and a second data message comprises several data segments.

FIG. 5: An example in which a first data message comprises the header and each subsequent data message comprises a segment.

FIG. 6: an example in which the header is encoded by a superposition of several Barker sequences.

### DETAILED DESCRIPTION

### Definitions

In the following description:
A radio signal is an electromagnetic wave propagated by non-wireless means, with frequencies ranging from a few kilohertz up to several hundred gigahertz.
A “first data message MES₁” is a sequence of bits transmitted by means of a modulated signal in the UWB (Ultra-Wide Band).
In the rest of the description, the arrival time of a data message MESₙ refers to:
   Either receiving the information contained in the data message, e.g. one or more useful data DATAₙ encoded in one or more segments,
   Or receiving and generating a reference time marker T_{sync}, which will be used as a reference, for example, to calculate one or more autocorrelation peaks of subsequent segments received.
Codes are referred to as “superimposed” when at least one bit of one code is replaced by another code. In this case, the codes replacing each bit are referred to as “internal” codes. The code for which at least one bit is replaced by another code is referred to as an “external” code. These superimposed codes form “layers” of codes. Internal” and “external” codes can, for example, be identical codes, inverse codes or codes that differ from one another. They can also be a combination of these examples, for example, Barker sequences of the same or different lengths.
Pseudo-random codes refer to codes that comprise a set of bits. Subsets of bits are designated to refer to part of these sets. Operations can be applied to these sets or subsets, such as time-shift operations to move a subset of bits to a different position in a data segment Sₙ
A position of a bit in a data segment Sₙ refers to a temporal position of said data bit. For example, when referring to the first position in a data segment, it means the bit that is read and decoded first by the receiver. So, when performing a time-shifting operation on a sub-set of bits in a data segment to shift this sub-set to the first position, it means that this sub-set of bits starts at the first position in the data segment Sₙ and will be decoded first by the receiver.
An initial pseudo-random code refers to a pseudo-random code to which operations can be applied to obtain a different pseudo-random code. Such operations may, for example, involve encoding a bit, a set of bits or a sub-set of bits by one or more identical or different pseudo-random codes to produce the first pseudo-random code PN₁ or the second pseudo-random code PN _{.2}
A first pseudo-random code is referred to as a “replacement” pseudo-random code, replacing a data bit of the initial pseudo-random code.
In some cases, the first pseudo-random replacement codes may themselves include pseudo-random replacement codes, referred to as “second pseudo-random replacement codes”. This makes it possible to create “layered” codes (one or more bits of the pseudo-random codes are replaced by other pseudo-random codes). This makes it possible to artificially create larger codes. These replacement pseudo-random codes can be used, for example, to form the first pseudo-random code PN₁ and/or one or more second pseudo-random codes PN₂.

In the remainder of this description, we will refer to the special case of geolocation using a UWB transmitter device which transmits a signal to a receiver device. Such a UWB transmitter comprises, for example, a radio tag.

For example, the transmitter is positioned on a particular object whose position in a particular environment, such as a closed warehouse, is to be accurately determined. The UWB transmitter can also be affixed to a moving object passing in sufficient proximity to a receiving device so that the signal emitted by said transmitter is picked up by the receiver.

The UWB transmitter can be electrically passive, i.e. it operates only when it is supplied with power by remote equipment via a wireless link, such as a UHF source. The UWB transmitter can also be electrically active, i.e. it is physically and constantly connected to a power supply source, such as a battery.

The UWB transmitter comprises transmission means for transmitting UWB radio signals to a receiving device. The transmission means comprise, for example, an antenna, a processor, a local oscillator, analog and/or digital filters and a power amplifier.

The receiver device comprises receiving means for receiving radio signals from the UWB transmitter. Such means include, but are not limited to, an antenna, a demodulator, one or more correlators, an analog/digital converter, an amplifier, a processor and a local oscillator.

It is by no means excluded that the invention applies to different implementations, as long as a message is encoded and transmitted from a transmitting device to a receiving device.

The following description is based on various embodiments of the invention, in which pseudo-random codes with or without Barker sequences are used.

Different embodiment of variants are described in each of these embodiments, which can be applied to one or more of these embodiments. Thus, the features described in one embodiment are directly applicable to another embodiment. The invention protects these different combinations of features described across all the embodiments.

### Data Messages

According to a first aspect, with reference to FIGS. 1, 4 and 5, the invention relates to a method of encoding at least one MES data message_{1 . . .} MESₙ. A “second MES data message₂”, a “third MES data message₃”, etc. up to an “nₜₕ data MES messageₙ” are hereafter referred to describe successive data messages transmitted by the UWB transmitter.

In the remainder of this description, we will refer to the header HEAD as a sequence of bits in the first encoded MES data message₁ including a time reference T._{sync}

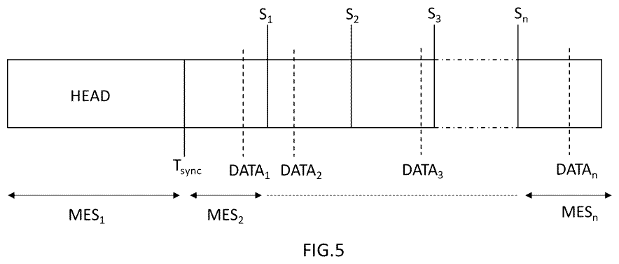

According to various examples, data messages MES₁ . . . MESₙ comprise:
Let the header HEAD be followed by n data segments, each segment comprising a useful data DATAₙ to be decoded by a receiver, as illustrated in FIG. 1;
Either the header HEAD alone, as shown in FIG. 4;
Or n-segment(s) of data without the header HEAD, as shown in FIGS. 4 and 5. In FIG. 4, the second MES data message₂ encodes all user data (DATA₁ . . . DATAₙ). In FIG. 5, each data message encodes a segment of user data (DATA₁ . . . DATAₙ).

More generally, a data message MES_{1 . . .} MESₙ can include all or part of the message to be transmitted and encoded in the header HEAD and n-segments.

In one embodiment, at least one MES_{1 . . .} MESₙ data message is transmitted in “on-off keying” mode. In this case, the “0s” of the PN₁ and PN₂ pseudo-random codes are not transmitted. One advantage is to reduce energy consumption by only emitting part of the energy when transmitting said pseudo-random codes PN₁ and PN₂.

In one embodiment, at least one data message MES₁ . . . MESₙ is transmitted using BPSK or Binary Phase Shift Keying modulation. In this case, the binary information to be transmitted via the MESₙ data message is carried by a reference signal, also referred to as a “carrier” in the scientific literature.

### Header Generation and First Pseudorandom Code

Referring to FIGS. 1, 4 and 5, the encoding of at least one message MES_{1 . . .} MESₙ includes the generation of the header HEAD.

The bit sequence of the transmitted header HEAD can comprise one or more bit sequences, which can be of the same or different lengths. It can also comprise several concatenated bit sequences of the same length. Stuffing” bits can be integrated into the sequence in the event that a transmitted useful data is not a multiple of the length of a bit sequence. Parity” and “imparity” bits can also be included in the sequence to detect a transmission error in a transmitting device.

The header HEAD is transmitted to the receiver upstream of the transmission of a plurality of segment Sₙ in which an autocorrelation function is to be determined. This autocorrelation function is determined, for example, from a time reference T_{sync} defined by a time position in the header HEAD bit sequence.

A particular interest of the header HEAD lies in the generation of a temporal reference marker, to establish the start of a sequence comprising useful data to be decoded by the receiver. The header HEAD aims to establish a demarcation between the time reference T_{sync} and one or more sequences of data bits comprising useful data DATA₁ . . . DATAₙ. By “useful data” we refer to data defining a message, or information to be transmitted within an encoded MES₁ . . . MESₙ data message. Examples include an identifier for the transmitting device, or location data.

Another advantage of the header HEAD is that it serves as a reference point for measuring the arrival time of an MES₁ . . . MESₙ data message. According to one example, the receiver's reception, reading and decoding of the message encoding the header HEAD results in the generation of the reference time marker T_{sync}. Such a marker defines a time reference for determining the arrival time at the receiver of one or more MES₁ . . . MESₙ data messages.

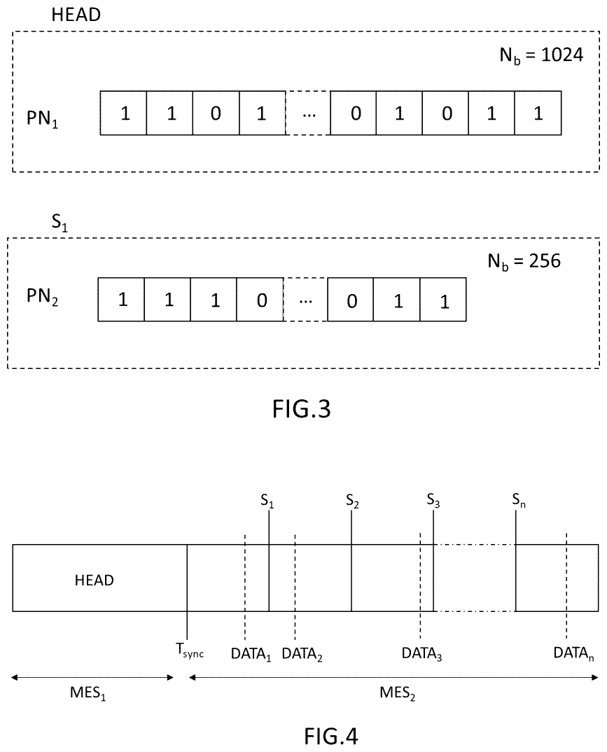

According to an embodiment, with reference to FIG. 3, the header HEAD is encoded by a first pseudo-random code PN₁. In the remainder of this description, the terms “pseudo-random code” and “pseudo-random sequence” are considered equivalent and are intended to designate the same code.

In one embodiment, the first pseudo-random code PN₁ is known to the transmitting and/or receiving device.

In one embodiment, the first pseudo-random code PN₁ comprises an n-sequence binary sequence. However, this does not preclude the use of different sequences to encode the header HEAD, such as one of the following sequences: a Kasami sequence or a Hadamard-Walsh sequence. According to an embodiment, the size of the first pseudo-random code PN₁ takes any value in number of bits N_{b} from the following list of values: [2¹, 2², 2³, 2⁴, 2⁵, 2⁶, 2⁷, 2⁸, 2⁹, 2¹⁰, 2¹¹, 2¹²]. In this case, there are N_{b} possible sequences for the first pseudo-random code PN₁. Advantageously, the choice of a particular value among the aforementioned values optimizes the arrival time of the first data message MES₁ at the receiver. This improves the location accuracy of the transmitting device.

In a preferred embodiment, the first pseudo-random code PN₁ comprises a Barker code. A “Barker code” or “Barker sequence” is equivalently designated to refer to a finite sequence of N values. Each value can be either +1 or −1, with an ideal autocorrelation property such that the off-peak (non-cyclic) autocorrelation coefficients are as small as possible.

For ease of reading, “a three-bit Barker sequence” refers to a Barker sequence of length three bits, “a seven-bit Barker sequence” refers to a Barker sequence of length seven bits, “an eleven-bit Barker sequence” refers to a Barker sequence of length eleven bits, and so on, depending on the length of a given Barker sequence.

In one embodiment, the first pseudo-random code PN₁ comprises a Barker eleven sequence. This is, for example, the following sequence: [+1+1+1−1−1−1+1−1−1+1−1]. In alternative embodiments, the first pseudo-random code PN₁ comprises a Barker two, three, seven or eleven sequence. The Barker two sequence is, for example, [+1−1]. The Barker three sequence is, for example, [+1+1−1]. The Barker seven sequence is, for example, [+1+1+1−1+1−1].

One advantage is to obtain a minimum autocorrelation value from a minimum sequence of data bits.

In one embodiment, the first pseudo-random code PN₁ is generated from an initial pseudo-random code.

### Header: Layered Code/LBPM

In one embodiment, the header HEAD is encoded by several superimposed first pseudo-random codes PN₁. Superimposed” means that at least one bit of a code is replaced by another code. In this case, the codes replacing each bit are referred to as “internal” codes. The code on which at least one bit is replaced by another code is referred to as an “external” code. Codes superimposed in this way form code “layers”. Internal” and “external” codes are, for example, identical codes, inverse codes or different codes. They can also be a combination of these examples. For example, Barker sequences of the same or different sizes.

For example, a bit of value “1” in an external code can be replaced by a Barker code of a given length, and a bit of value “−1” can be replaced by the inverse Barker code of that Barker code.

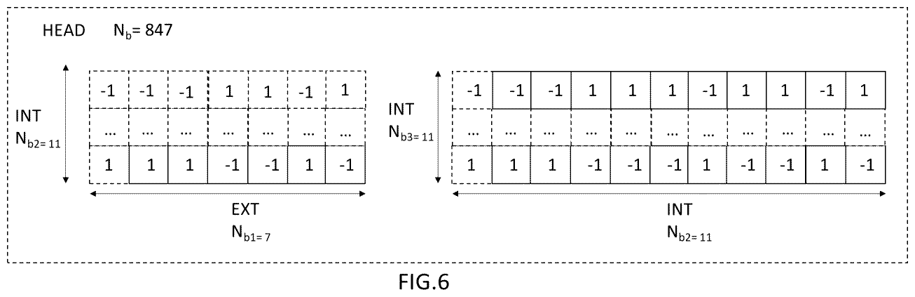

FIG. 6 illustrates an example of this mode, in which the header HEAD is encoded by a plurality of superimposed Barker sequences. These are Barker seven and Barker eleven sequences. The outer code forming the upper layer is a Barker seven sequence. The inner codes forming the lower layers are Barker eleven sequences. In this case, each bit of the Barker seven sequence is replaced by a Barker eleven sequence, and each bit of the Barker eleven sequence is replaced by another Barker eleven sequence. The result is a header of size 7*11*11=847 bits.

The example described above is not restrictive. It is also possible to use Barker sequences of different sizes for the “inner” and “outer” codes forming the header HEAD. The outer code may, for example, comprise an eleven Barker sequence and the two inner codes may, for example, comprise two eleven Barker sequences. In this case, the header HEAD is 11*11*11=1331 bits. It is also possible to form more inner layers, e.g. three inner layers, four inner layers, and so on.

One advantage is to reduce the autocorrelation phenomenon, while limiting the system's energy consumption and maintaining good transmitter location accuracy.

Another advantage is to achieve higher performance than using a standard PN code, while using a smaller code size.

Another advantage is the delay between header HEAD decoding and data decoding. Another advantage is to obtain a signal with good noise resistance. Another advantage is to round off the code to an even number of bits. Another advantage is to obtain a low autocorrelation threshold while optimizing the system's energy consumption. Another advantage is to define a reliable benchmark for decoding useful data. Another advantage is to define a time-of-arrival benchmark for the localization system. Indeed, a longer code provides a better signal-to-noise ratio and improves arrival time estimation.

### Useful Data

According to an embodiment, at least one data message MES_{1 . . .} MESₙ comprises a data segment Sₙ.

A data segment Sₙ is a sequence of data bits. Each data segment Sₙ is positioned, for example, after the header HEAD in a data message MES₁ . . . MESₙ. Each data segment Sₙ comprises, for example, useful data values DATA_{1 . . .} DATAₙ. The useful data values DATA_{1 . . .} DATAₙ comprise, for example, information to be transmitted to the receiver, such as transmitter identification information. For example, one or more symbols of a sender identifier. The useful data values DATA_{1 . . .} DATAₙ may also comprise location data.

Each useful data is encoded, for example, on a given bit sequence of a given segment Sn of a second pseudo-random code PN₂. An autocorrelation function is implemented, for example, for each segment Sₙ of the data message MES_{1 . . .} MESₙ, so as to determine the position and value of each bit comprising the useful DATA₁ . . . DATAₙ.

This implementation is particularly advantageous when each segment Sₙ is encoded in the same second pseudo-random code PN₂. In this case, determining the position of each peak on which autocorrelations are performed makes it possible to determine the values of the bits, and therefore to decode all the useful data transmitted within the first data message MES₁.

In one embodiment, several segments Sₙ of a data message MES_{1 . . .} MESₙ each include symbols of a UWB transmitter identifier. In this case, by decoding all the segments of the first data message MES₁ at the receiver, an identifier of the transmitting device can be reconstructed.

In one embodiment, the useful data DATA_{1 . . .} DATAₙ values comprise an information on the position of the transmitter. This may be made possible, for example, when the transmitter comprises a communication interface and a memory. For example, the transmitter receives information about its location from a third-party device, such as a GPS system. It may also be a UWB beacon system that has reconstructed the position of the transmitter using trilateration position calculations.

In one embodiment, the useful data values DATA_{1 . . .} DATAₙ comprise timestamp data. These are, for example, timestamp data of the instant of transmission of the data message MES₁ by the transmitter. In this case, the transmitter comprises, for example, a built-in clock and a memory for storing data.

According to an embodiment, the useful data values DATA_{1 . . .} DATAₙ are encoded from a predefined time marker with respect to the time reference T_{sync}. The time marker is, for example, positioned at an autocorrelation peak of the second pseudorandom code PN2.

### Encoded Data/Layered Code/LBPM

In one embodiment, the useful data values DATA₁ . . . DATAₙ are encoded by a second pseudo-random code PN₂. This is, for example, a binary sequence of the n-sequence type. However, this does not preclude the use of different sequences, such as a Kasami sequence or a Hadamard-Walsh sequence.

According to an embodiment, the size of the second pseudo-random code PN₂ takes any value in number of bits N_{b} from the following list of values: [2¹, 2², 2³, 2⁴, 2⁵, 2⁶, 2⁷, 2⁸, 2⁹, 2¹⁰, 2¹¹, 2¹²]. Consequently, there are N_{b} possible sequences for the second pseudo-random code PN₂. Advantageously, the code size chosen for the second pseudo-random code PN₂ depends on the size of the first pseudo-random code PN₁, which is longer for example, so as to optimize data transmission and detection of the arrival time of a data message MES_{1 . . .} MESₙ. However, nothing precludes the use of PN₁ and PN₂ pseudo-random codes of the same size within the scope of the invention.

In one embodiment, the second pseudo-random code PN₂ encoding the useful data DATA_{1 . . .} DATAₙ comprises a Barker sequence. For example, a Barker sequence two, a Barker sequence three, a Barker sequence seven or a Barker sequence eleven. The Barker two sequence is, for example, [+1−1]. The Barker three sequence is, for example, [+1+1−1]. The Barker seven sequence is, for example, [+1+1+1−1+1−1]. However, this does not preclude the use of Barker sequences of different sizes or layout.

According to one embodiment, at least one data message MES₁ . . . MESₙ is encoded by a superposition of a plurality of second pseudo-random codes PN₂. Codes are “superimposed” by the fact that at least one bit of a code is replaced by another code. In this case, the codes replacing each bit are referred to as “internal” codes. The code for which at least one bit is replaced by another code is referred to as an “external” code. Codes superimposed in this way form code “layers”. Internal” and “external” codes are, for example, identical codes, inverse codes or different codes. They can also be a combination of these examples. For example, Barker sequences of the same or different sizes.

These are, for example, pseudo-random codes of 127 bits in length. Another example is a superposition of Barker sequences. One advantage is that a delay can be set up between the decoding of several consecutive data messages.

According to a first illustrative example, the data message MES₁ . . . MESₙ is encoded by a superposition of two Barker eleven sequences. In this case, the final code length is 11×11=121 bits. The code is extended by 7 bits of value 0, to obtain a final code of 128 bits. One advantage is that a delay can be implemented between the decoding of several consecutive data messages. Another advantage is to round up the code to an even number of bits.

According to another illustrative example, at least one data message MES₁ . . . MESₙ is encoded over 30 sequences of 4 data bits. In this case, the data message MES₁ . . . MESₙ carries 120 data bits.

According to another illustrative example, at least one MES₁ . . . MESₙ data message is encoded by 40 second PN₂ pseudo-random codes, each comprising a Barker sequence. Each Barker sequence carries, for example, 4 data bits. In this case, the MES₁ . . . MESₙ data message carries 160 bits of data.

In one embodiment, the data bits carried by at least one data message MES₁ . . . MESₙ comprise error correction bits. These error correction bits correspond, for example, to half of the data bits carried by the data message MES₁ . . . MESn. For each data message MES₁ . . . MESn, UWB pulses are transmitted by the UWB transmitter every 2 nanoseconds, for example, with a latency of 40 nanoseconds between two pulses, giving a data rate of 25Mbytes/second. One advantage is to implement large error correction parameters that enable more robust communication between transmitting and receiving equipment under difficult conditions, such as interference-prone communication conditions.

According to an embodiment, the useful data values DATA₁ . . . DATAₙ are encoded by a second pseudo-random code PN₂ shorter than the first pseudo-random code PN₁. By “shorter code” we mean that the second pseudo-random code PN₂ comprises a number of bits N_{b} less than the number of bits N_{b} of the first pseudo-random code PN₁.

One advantage of using a short pseudo-random code is to reduce the transmission time at the transmitting device. As a result, noise is advantageously reduced for the overall system. Indeed, considering a case where the system comprises a plurality of transmitters, two messages transmitted at random times by two transmitting devices have a lower probability of being transmitted at the same time if the transmission time of one of the messages is shorter. This reduces the risk of interference. Another advantage is to reduce the complexity of the calculations carried out in the correlators of the receiving device, and thus to reduce the system's energy consumption. Another advantage is that the radio channel is occupied for less time.

According to an embodiment, the useful data DATA₁ . . . DATAₙ are encoded with a time delay with respect to the time reference T_{sync}.

According to an embodiment, a time marker T₁ is associated with a portion of a data segment Sₙ comprising the useful data DATA₁ . . . DATAₙ. This time marker corresponds, for example, to the instant at which the useful data DATA₁ . . . DATAₙ begins to be decoded by the receiver. In a variant, the time marker corresponds to the instant at which decoding of at least some of the useful data DATA₁ . . . DATAₙ is completed. In this case, the time marker T₁ is, for example, positioned to demarcate the end of a first segment Sₙ and the start of a second, subsequent segment Sₙ₊₁. This mode of the invention is not limited to the aforementioned examples. The time marker T₁ can be positioned at any position of a data message MES₁ . . . MESₙ to mark a given portion of said message.

In one embodiment, the decoding of a MES_{1 . . .} MESₙ data message by the receiver results in the automatic generation of a plurality of time stamps T_{1 . . .} Tₙ. For example, a first time marker T₁ is generated following decoding of the first segment S₁ by the receiver, and a second time marker T₂ can be generated following decoding of the second segment S₂ by the receiver, and so on until all the segments Sn of the first MES data message₁ have been decoded. Each time marker T₁ . . . Tₙ is defined, for example, in relation to the time reference T_{sync} defined following decoding of the header HEAD, or in relation to a time reference Tₙ₋₁ defined following decoding of a previous segment. One advantage is to generate a time marker of the arrival time at the receiver of each segment Sₙ of a data message MES₁ . . . MESₙ

According to an embodiment, at least one data message MES₁ . . . MESₙ comprises a plurality of segments Sn which are all encoded by an identical pseudo-random code. This is, for example, the second pseudo-random code PN₂. The use of the same code makes it possible to achieve autocorrelation when decoding the MES₁ . . . MESₙ data message. One advantage is to reduce noise within the MES₁ . . . MESₙ data message.

One advantage is to avoid the phenomenon of “cross-correlation”, which causes coherent noise between codes when several different pseudo-random codes are used. According to one example, an autocorrelation peak is reached when the correlation value exceeds a predetermined threshold. In this case, a sufficiently high threshold is chosen, for example, to avoid detecting a “false” autocorrelation peak. In this case, a sufficiently low threshold is also chosen to avoid missing the autocorrelation peak (e.g. in the case where the message transmitted by the transmitter is disturbed by interference on its way to the receiver, and the maximum correlation value is therefore not reached). According to another example, the receiver detects the code received with the highest correlation value at the precise moment of message arrival. This correlation value depends in particular on the distance to the header HEAD.

Another advantage is to optimize the arrival time of data messages at the receiver. In the case where the receiver is used a posteriori to determine a position of the transmitter, for example when the receiver comprises a UWB beacon implementing calculations to reconstruct the position of the transmitting device by trilateration with other beacons, a better precision on the position of the transmitter is advantageously obtained.

According to one embodiment, the encoding of each segment Sₙ by the second pseudo-random code PN₂ comprises the encoding of at least one symbol by said second pseudo-random code PN₂. Each symbol is, for example, encoded on one bit of each segment Sₙ. According to another example, a plurality of symbols is encoded on a plurality of bits of each segment Sₙ. The useful data values DATA_{1 . . .} DATAₙ comprise, for example, all the symbols of each segment Sₙ. In this case, the encoded symbols define the message to be transmitted to the receiver, and decoding of the data message enables decoding of the bits comprising said symbols, which materialize, for example, a sender identifier.

In one embodiment, generating a given number of first or second pseudo-random codes PN₁, PN₂ to encode the data comprises generating the inverse codes of each first or second pseudo-random code PN₁, PN₂ generated.

One advantage is to double the number of possible autocorrelation values.

In one embodiment, the encoded symbols form a correction code. This is, for example, a Reed Solomon code. Such a code is, for example, encoded on 8 bits in a MES₁ . . . MESₙ data message. However, there is nothing to prevent such a correction code from being encoded on a greater or lesser number of bits in the MES data message₁. The Reed Solomon code formed is, for example, a reduced Reed Solomon code RS (28,14).

In one embodiment, at least one data message MES₁ . . . MESₙ is protected by an error detection code. The error detection code is, for example, a cyclic redundancy check (CRC) error detection code. For example, an 8bit CRC error detection code. The error detection code is positioned, for example, upstream of the MES data message₁ . . . MESₙ.

One advantage is the ability to detect unintentional data changes in transmitted data messages, for example due to interference or faults in the transmitter or receiver.

In one embodiment, all data messages MES₁ . . . MESₙ are protected by an error correction code. The error correction code comprises, for example, a concatenated error correction code, such as a Reed-Solomon code. For example, a Reed-Solomon code RS (28,14) with a generator polynomial equal to 1+x x²+³+x⁴+x⁸.

In one embodiment, at least one data message MES₁ . . . MESₙ is protected by a plurality of Reed-Solomon codes. These are, for example, two Reed-Solomon codes RS(15,2) with a generator polynomial equal to X⁴+X+1 on GF(4).

One advantage is that the data message can be reconstructed at the receiver following transmission errors.

In one embodiment, the process comprises the implementation of a spread spectrum. According to one example, this is direct sequence spread spectrum, also referred to by the acronym DSSS. Another example is frequency hopping spread spectrum, also known as FHSS.

One advantage is to make transmitted UWB signals more resistant to jamming and interference.

Another advantage is to increase the signal's resistance to fading.

Another advantage is the ability to hide the signal by increasing its resemblance to random noise.

Another advantage is that it makes the signal more difficult to intercept.

Another advantage is more efficient use of bandwidth, by allowing transmitted signals to share frequency bands with other types of transmitted signal.

In one embodiment, the process comprises a punctuation step. The punctuation step comprises, for example, the deletion of one or more parity bits in a bit sequence of one or more given segment(s). This step is carried out, for example, after encoding an MES_{1 . . .} MESₙ data message with an error correction code.

In one embodiment, the first pseudo-random code PN₁ and/or the second pseudo-random code PN₂ comprise a first Barker sequence and at least one data bit of said first Barker sequence is replaced by a second Barker sequence. The first and second Barker sequences are, for example, of identical length. They can also be of different lengths, for example an eleven Barker sequence and a seven Barker sequence.

In one embodiment, the second pseudo-random code PN₂ is generated from an initial pseudo-random code.

In one embodiment, the first pseudo-random code PN₁ and the second pseudo-random code PN₂ are generated from the same initial pseudo-random code. In one variant, they are generated from different initial pseudo-random codes.

In one embodiment, a plurality of second pseudo-random codes PN₂ are generated from the same initial pseudo-random code, on which successive shifts of at least one data bit are implemented. Successive shifts of at least one data bit” means that shifting at least one data bit generates a first second pseudo-random code PN₂. Subsequently, a shift of at least one data bit on the first second pseudo-random code PN₂ generates a second pseudo-random code PN₂. This operation can be repeated as many times as necessary to obtain the desired number of second pseudo-random codes.

According to one embodiment, a plurality of second pseudo-random codes are used to encode the useful data, said second pseudo-random codes being chosen so as to optimize the orthogonalization of the data codes with respect to each other.

According to one embodiment, the first pseudo-random code and/or the second pseudo-random code comprise a first Barker sequence and at least one data bit of said first Barker sequence is replaced by an artificial code comprising a second Barker sequence.

### Encoding with a Circular Offset

According to an embodiment, at least one second pseudo-random code PN₂ is constructed so as to associate with at least one useful data value DATA_{1 . . .} DATAₙ, a circular shift of said second pseudo-random code PN₂. By “circular shift” we mean a time shift of a sequence of data bits. To illustrate this mode, a detailed example of the invention is described below.

In this example, the second pseudo-random code PN₂ has a length of N_{b}=256 bits, i.e. 2⁸ bit shifting possibilities for said second pseudo-random code PN₂. The first MES data message₁ is encoded and the encoding of said message MES₁ includes the generation of the header HEAD. The header HEAD is encoded by the first pseudo-random code PN₁, which in this example has a length of N_{b}=1024 bits. The time reference T_{sync} is defined on the 1024^{ème} bit of the header HEAD, to mark the start of the transmitted message containing the useful data (the start of the first segment S₁). Encoding the first data message MES₁ involves generating 15 segments Sₙ. Each segment is encoded by the second pseudo-random code PN₂ (15 times the same code to encode all 15 segments). There are 256 possible positions for encoding the useful data DATA₁ in the first segment S₁ (due to the 256 1-bit shift possibilities for the second pseudo-random code PN₂). A symbol is encoded from the 52^{nd} position of the first segment S₁, and corresponds to the useful data DATA₁. A time shifting operation of the data bits of the second pseudo-random code PN₂ is implemented, so as to shift the code at 52^{nd} position (which includes the useful data) to the first position of the first segment S₁. In this way, the autocorrelation peak is advantageously shifted to the first position of the first segment S₁. The data message MES₁ generated by the UWB transmitter is then transmitted to a UWB receiver, which receives, stores and decodes said data message MES₁. A first step in receiving the data message MES₁ is to store and read the header HEAD. By reading the header HEAD and determining a first autocorrelation function of the first pseudo-random code PN₁, it is possible to determine the time reference from which the message comprising DATA₁ useful data begins. A second step in receiving the data message MES₁ is to receive and store the 2⁸ possible data codes for the first segment S₁.

In this example, the receiver comprises two correlators. The decoding of the useful DATA₁ included in the MES data message₁ corresponds to the calculation of an autocorrelation function by one of the correlators. Several data messages MES₁ . . . MESₙ are continuously transmitted by the UWB transmitter to the receiver. The arrival time of an MES₁ . . . MESₙ message corresponds to the moment when the autocorrelation function is calculated by the correlator decoding said MESₙ message. While the autocorrelation function of the first MES message is being calculated, a second message MES₂ is sent from the UWB transmitter to the receiver. The second correlator stores the second message MES₂ while the first message MES₁ is decoded by the first correlator. In this way, data messages are advantageously decoded continuously.

For example, when a third data message MES₃ is transmitted from the transmitter to the receiver, the first data message MES₁ will have been decoded and said third data message MES₃ can be read and stored by the first correlator while the second data message MES₂ is decoded by the second correlator. This process can be carried out continuously. The system's energy consumption is optimized by the continuous implementation of the transmission, reception and decoding steps for all data message MESₙ.

One advantage of using the same pseudo-random code PN₂ to encode the data is that the codes are of the same length (in our example 256 bits). This means that searching for the autocorrelation function on the 256 bits of the first segment S₁ takes approximately the same amount of time as storing the 256 bits of the second segment S₂. It is therefore possible to alternate between storing and decoding at the level of the two correlators, and thus to continuously store and decode data messages MESₙ sent by the UWB transmitter.

The example described above is intended to illustrate an example of encoding in “circular” mode; however, it is understood that the invention is not limited to this example. For example, PN codes of different lengths can be used, such as 128-bit PN codes, 512-bit PN codes, etc., or a header of different size, such as a 256-bit header, 512-bit header, 2048-bit header, etc., can be used. It is also possible to circularly shift the data bits of the second pseudo-random PN code₂ by more than 1 bit. Circular shifts of 2 bits, for example, are possible, i.e. 128 shifts for a 256-bit pseudo-random code. In another example, the code is 128 bits long and 8-bit circular shifts are performed. In this case, 16 different circular shifts of data bits are possible. One advantage of such an implementation is to provide additional temporal security for the detection of autocorrelation peaks in the data segments (Sₙ), and therefore to ensure that the useful data is not missed when the receiver decodes the data messages.

In different cases, the receiver can also comprise a number of correlators different from the number of two correlators described in the example, for example 3, 4, 5, 6 up to 256 correlators depending on the use case.

One advantage of using 256 correlators is the certainty of detecting the autocorrelation peak of a given segment of the MES data message₁. Indeed, in the case where the data segment comprises 256 bits and the useful data DATA₁ is encoded on a byte of said segment, at least one of the 256 correlators will detect a maximum which corresponds to the autocorrelation peak and therefore to the decoding of the useful data DATA₁. Another advantage of using 256 correlators is that it provides a second, precise measure of the arrival time of the first data message MES₁. In this case, the arrival time of the data message MES₁ corresponds to the time between the transmission of the first data message MES₁ by the UWB transmitter and the determination of the autocorrelation peak by one of the UWB receiver's correlators.

In one embodiment, at least one first pseudo-random code PN₁ or at least one second pseudo-random code PN₂ is formed from the same initial pseudo-random code, to which a circular time shift of a given number of bits N_{b} is applied. In this case, the code is folded back on itself in a circular fashion following the time shift to generate a code of the same length as the initial code. For example, eight different codes of the same length can be built on the basis of the same initial Barker sequence, by implementing eight circular time shifts of different data bits. It is possible to obtain 16 different codes from these eight shifts, by generating the inverse codes of each of the codes obtained. One advantage is that 16 possible correlation values can be obtained.

In one embodiment, at least one first or second pseudo-random code PN₁, PN₂ is formed by a circular time shift of 8 bits from an initial pseudo-random code. Further codes are, for example, formed from the initial pseudo-random code by a circular time shift of twice 8 bits for the second code, three times 8 bits for the third code and so on until the desired number of codes is obtained.

One advantage is to optimize the orthogonalization of data messages.

One advantage is the optimized decoding of data messages, which are all derived from the same initial code.

Another advantage is that a minimum autocorrelation value can be achieved by time-shifting a minimum number of data bits.

### Differential Mode

According to an embodiment, the time reference T_{sync} used to determine the autocorrelation function of a segment Sₙ of a data message MES₁ . . . MESₙ corresponds to a time marker of the beginning of a previous segment Sₙ₋ₓ.

One advantage is that it is possible to use pseudo-random codes PN₁ and PN₂ of substantially similar size for the header HEAD and for the various segments Sₙ of the data message MES₁ . . . MESₙ. In this case, the time reference T_{sync} can change on receipt of each new segment Sₙ. It is therefore possible to use a reduced header HEAD, which will be used, for example, only to determine the time reference T_{sync} used to calculate the autocorrelation function of the first segment S₁ received. Advantageously, the use of a first pseudo-random code PN₁ of similar size to the second pseudo-random code PN₂ reduces the overall size of the transmitted data message. As a result, the energy consumption of both transmitter and receiver is reduced.

In one embodiment, application of the second autocorrelation function comprises generating a circular shift of the at least one second pseudo-random code to generate a plurality of autocorrelation products.

In one embodiment, the circular shift of the second pseudo-random code is performed for 1 bit of data.

### Creating Artificial Code

In one embodiment, at least one MES_{1 . . .} MESₙ data message is encoded by an “artificial” code. By artificial code we mean a code comprising a number N_{b} of bits and for which at least one bit of the code corresponds to another data code. The data codes encoded by each bit of the MES_{1 . . .} MESₙ data message are, for example, the same size as the MES₁ . . . MESₙ data message. They can also be of different sizes, depending on the application.

In one embodiment, at least one bit of an MES₁ . . . MESₙ data message encoded by a second PN₂ pseudo-random code comprising a Barker sequence is replaced by an artificial code. According to one example, when an external code comprises a Barker sequence, the data bits equal to 1 can be replaced by another Barker sequence.

According to an illustrative example, the data message sent is the first MES data message₁ encoded by a first code of length N_{b}=3 bits. Each bit is associated with a code also of length N_{b}=3 bits, and with its inverse code. For example, the value “1” of the data bit corresponds to the 3-bit encoded code, and the value “0” of the data bit to its inverse code. In this case, a so-called “artificial” code is created, which advantageously enables a good correlation peak to be obtained from the first message MES₁ transmitted. In such an implementation, an “artificial” correlation amplifier is advantageously created.

According to one embodiment, the method comprises generating an artificial code from a pseudo-random code, said artificial code comprising a first data code comprising a predefined number of bits, at least one of the bits of said artificial code being encoded by another data code or by an inverse code of said data code.

### UWB Transmitter/UWB Receiver System

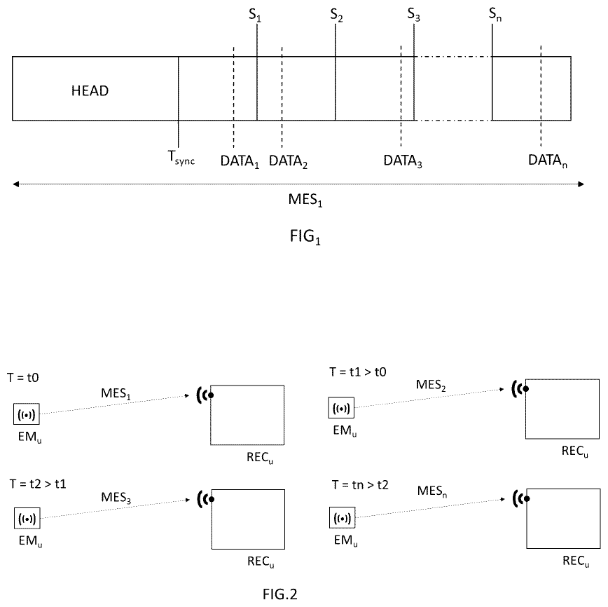

According to another aspect, with reference to FIG. 2, the invention relates to a system comprising a UWB EMᵤ transmitter and a UWB RECᵤ receiver. The elements of the system are configured to implement the process of the invention according to any of its embodiments.

The EMᵤ transmitter, for example, is positioned on a particular object whose position in a particular environment, such as a closed warehouse, is to be accurately determined. The EMᵤ transmitter can also be affixed to a moving object passing in sufficient proximity to a receiving device for the signal emitted by said transmitter to be picked up by the receiver. For example, the EMᵤ transmitter is electrically passive, i.e. it only operates when it is supplied with power by a remote device via a wireless link, such as a UHF source. Alternatively, the EMᵤ transmitter is electrically active, i.e. it is physically and constantly connected to a power supply source, such as a battery.

The EMᵤ transmitter includes means for transmitting UWB radio signals to a receiving device. Such means include, but are not limited to, an antenna, a processor, a local oscillator, analog and/or digital filters, a power amplifier and so on. The radio signals transmitted by the EMᵤ transmitter comprise, for example, a plurality of data messages MES₁ . . . MESₙ.

The RECᵤ receiver comprises means enabling it to receive electrical radio signals from the UWB transmitter. Such means include, but are not limited to, an antenna, a demodulator, a correlator, an analog/digital converter, an amplifier, a processor, a local oscillator, etc. . . .

The RECᵤ receiver, for example, includes a processing circuit, comprising one or more processors and storage means (e.g. an electronic memory) in which a computer program product is stored, in the form of a set of program code instructions to be executed in order to implement the various stages of the process for estimating the time of arrival of a data message MES₁ . . . MESₙ. Alternatively, or additionally, the processing circuit comprises one or more programmable logic circuits (FPGA, PLD, etc.), and/or one or more specialized integrated circuits (ASIC), and/or a set of discrete electronic components, etc., adapted to implement all or part of said steps of the method for decoding an data message MES₁ . . . MESₙ.

In a preferred mode, the communication links enabling the EMᵤ transmitter and the RECᵤ receiver to communicate with each other are non-wireless communication links. However, nothing prevents the invention from being implemented in a mode where the communication links between the EMᵤ transmitter and the RECᵤ receiver are wired communication links.

In one embodiment, the RECᵤ receiver comprises at least two correlators. Each correlator is configured to receive and decode MES₁ . . . MESₙ data messages transmitted by the EMᵤ transmitter. By “decode” is meant the calculation of an autocorrelation function of the pseudo-random codes encoding the transmitted MES₁ . . . MESₙ data messages. According to an example in which the RECᵤ receiver comprises two correlators, the correlators are configured to alternately store and decode the data messages MES₁ . . . MESₙ transmitted by the EMᵤ transmitter.

In a preferred mode, the data messages MES₁ . . . MESₙ transmitted by the EMᵤ transmitter are of the same size, for example 8 bits. In this case, the time taken by the correlators to store and decode each data message is substantially the same. This enables the system to operate continuously. Advantageously, the system's energy consumption is reduced (since the transmitter does not operate continuously “in a vacuum”). Messages transmitted by the transmitter are instantly received and decoded by the receiver. Another advantage is optimized use of the radio channel.

### System with Multiple UWB Receivers

According to another aspect, the invention relates to a system comprising a UWB transmitter configured to implement any of the steps of the process according to the invention and a plurality of UWB receivers. The plurality of UWB receivers implemented is, for example, a plurality of UWB beacons. The UWB beacons may be three or four in number, depending on the application. For example, the use of a system comprising three beacons advantageously enables the position of the transmitter to be reconstructed along two axes x and y (in two directions), using position calculations by trilateration. The use of a fourth beacon in the system enables the position of the transmitter to be reconstructed by trilateration with greater precision, by introducing position data for the transmitter along a vertical axis.

The EMᵤ transmitter or the RECᵤ receiver include, for example, a computing module. This computing module comprises, for example, one or more processors capable of interpreting instructions in the form of a computer program, a programmable logic circuit, such as an application-specific integrated circuit (ASIC), a field programmable gate array (FPGA), a programmable logic device (PLD) and programmable logic arrays (PLA), a system-on-a-chip (SOC), an electronic board in which steps of the process according to the invention are implemented in hardware elements. Processing can be carried out by one processor, or simultaneously or sequentially, or by another method, by one or more processors.

The calculation module comprises a data processing module for performing calculations and a memory, operatively coupled to the data processing circuit.

The EMᵤ transmitter or the RECᵤ receiver also include an input device, an output device and a communication device.

Each function is performed by causing the data processing module to read a predetermined program from hardware such as memory so that the data processing module performs calculations, controls communications carried out by the communication device and to read and/or write data to the memory and computer-readable medium.

The EMᵤ transmitterᵤ includes, for example, a processing circuit comprising one or more processors and storage means (e.g. an electronic memory) in which a computer program product is stored, in the form of a set of program code instructions to be executed in order to implement the various steps for encoding a data message MES₁ . . . MESₙ.

The memory is a computer-readable storage medium, and can be configured with, for example, at least one of the following: Read-Only Memory (ROM), Erasable Programmable Read-Only Memory (EPROM), Electrically Erasable Programmable Read-Only Memory (EEPROM), Random Access Memory (RAM) and/or another suitable storage medium. The memory can include an operating system and load programs according to the invention. It includes registers suitable for storing parameter variables created and modified during execution of the aforementioned programs. The program product may comprise a computer-readable storage medium which is a tangible device, not being a transient signal per se such as, by way of example, but not limitation, a smart card, flash memory device, database, server, or other suitable storage medium.

Alternatively, the program instructions are taken from an external source and downloaded via a network. In this case, the computer program product comprises a computer-readable data carrier on which the program instructions are stored, or a data carrier signal on which the program instructions are encoded.

The invention also relates to a computer program product comprising the computer-readable medium containing instructions which, when executed by the circuit, cause the EMᵤ transmitter to implement the steps of the method of encoding at least one data message MES₁ . . . MESₙ of the invention.

The form of the program instructions is, for example, a source code form, a computer-executable form or any intermediate form between a source code and a computer-executable form, such as the form resulting from conversion of the source code via an interpreter, assembler, compiler, linker or localizer. Alternatively, the program instructions are microcode, firmware instructions, state definition data, IC configuration data (e.g. VHDL) or object code. The program instructions are written in any combination of one or more programming languages, e.g. an object-oriented programming language (C++, JAVA, Python), a procedural programming language (e.g. C language).

The system can include a user interface comprising an input device and an output device. The user interface comprises an input device for allowing a user to enter data or commands so as to be able to interact with the programs according to the invention. The output device is designed to output information to a user, either sensorially or electrically, e.g. visually or acoustically.

The set of at least one communication device enables communication between elements of the system and possibly between at least one element of the system and a device external to the system. This communication device can establish a physical link between elements of the system and/or between an element of the system and a device external to the system and/or a remote (wireless) communication link between elements of the system and/or between an element of the system and a device external to the system.

1. A computer-implemented method for encoding at least one data message intended to be transmitted by a ultra-wide band (UWB) transmitter to a UWB receiver, the method comprising:
generating a header encoded by a first pseudo-random code, said header defining a time reference after which a sequence of data segments is intended to be transmitted;
generating the sequence of data segments, each data segment encoding at least one useful data value using a second pseudo-random code and based on:
the time reference,
a position of the data segment in the sequence;
an autocorrelation peak of the second pseudo-random code.

2. The method according to claim 1, wherein each data segment comprises a set of bits, the method comprising a time shifting operation of a subset of bits, encoding the useful data value of at least one data segment in the sequence of data segments to position said subset of bits in the first position in the data segment.

3. The method according to claim 1, comprising generating the first pseudo-random code and/or the second pseudo-random code from an initial pseudo-random code.

4. The method according to claim 3, comprising generating the first pseudo-random code or the second pseudo-random code by replacing at least one bit of the initial pseudo-random code with a replacement pseudo-random code.

5. The method according to claim 4, wherein generating the first pseudo-random code or the second pseudo-random code comprises replacing each bit of the first replacement pseudo-random replacement code with a second replacement pseudo-random code.

6. The method according to claim 4, wherein the initial pseudo-random code comprises a first Barker sequence, and wherein the first pseudo-random replacement code comprises a second Barker sequence.

7. The encoding method according to claim 3, comprising generating a plurality of second pseudo-random codes from the initial pseudo-random code by successively applying time shifts of a predefined number of bits to the initial pseudo-random code, and wherein generating the set of segments is performed using the plurality of second pseudo-random codes.

8. The encoding method according to claim 1, wherein the first pseudo-random code has a number of bits greater than the number of bits of the second pseudo-random code₂.

9. A computer-implemented method for locating a transmitter comprising encoding the data message according to claim 1, the method comprising receiving a plurality of data messages by a plurality of UWB beacons, each beacon comprising a clock, said receiving comprising:
synchronizing the clocks of the UWB beacon;
time-stamping, by each clock, the reception of the data messages;
calculating the position of the transmitter from the data messages received by the plurality of UWB beacons.

10. A computer-implemented method for decoding at least one data message encoded by the method according to claim 1, and transmitted by a UWB transmitter comprising:
measuring a first incoming signal, demodulation of the first incoming signal and calculation of a first autocorrelation function of the demodulated signal;
determining a first autocorrelation peak of the first autocorrelation function;
determining the time reference from said first autocorrelation peak;
measuring a plurality of second arrival signals, demodulating the second arrival signals and, for each second arrival signal:
calculating a second autocorrelation function for the second demodulated signal;
determining a second autocorrelation peak of the second autocorrelation function;
measuring a time offset between the time reference or the beginning of a data segment and the second autocorrelation peak.

11. The method according to claim 10, wherein applying the second autocorrelation function comprises a time-shifting operation of a subset of bits to generate a plurality of autocorrelation products.

12. A UWB transmitter comprising a calculator configured to carry out the steps of the encoding process according to claim 1.

13. A UWB receiver comprising a calculator configured to carry out the steps of the decoding process according to claim 1.

14. A system for encoding and decoding at least one data message comprising a UWB transmitter according to claim 12.

15. A system for encoding and decoding at least one data message comprising a UWB transmitter according to claim 12 and
a plurality of UWB beacons each comprising:
i. a clock for measuring time-stamp data of the reception of data messages transmitted by the UWB transmitter;
ii. a calculator for:
synchronizing the clocks of the plurality of UWB beacons with each other;
calculating, by trilateration, the position of the UWB transmitter at the origin of the data message.
